(19) United States
(12) Patent Application Publication
(10) Pub. No.: US 2025/0170441 A1
(43) Pub. Date: May 29, 2025

(54) SYSTEMS AND METHODS FOR VARIABLE RATE FIRE SUPPRESSION

(71) Applicant: Tyco Fire Products LP, Cranston, RI (US)

(72) Inventor: Sean S. Troutt, Stephenson, MI (US)

(73) Assignee: Tyco Fire Products LP, Cranston, RI (US)

(21) Appl. No.: 18/840,306

(22) PCT Filed: Mar. 23, 2023
(86) PCT No.: PCT/IB2023/052891

§ 371 Date: Aug. 21, 2024

Related U.S. Application Data
(60) Provisional application No. 63/323,624, filed on Mar. 25, 2022.

(51) Int. Cl. A62C 37/36; A62C 3/06; A62C 3/07; A62C 3/16

(52) U.S. Cl. CPC A62C 37/04; A62C 3/06; A62C 3/07; A62C 3/16

(57) ABSTRACT

A container system includes a container, and a suppression system. The container defines an inner volume, and battery cells positioned within the inner volume. The suppression system is configured to discharge suppressant agent into the inner volume of the container. The suppression system is configured to discharge the suppressant agent into the inner volume of the container at a variable rate in order to provide initial fire suppression, and continuous subsequent cooling of the plurality of battery cells.

### CROSS-REFERENCE TO RELATED PATENT APPLICATION

This application claims the benefit of and priority to U.S. Provisional Application No. 63/323,624, filed Mar. 25, 2022, the entire disclosure of which is incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

One embodiment of the present disclosure is a container system. The container system includes a container, and a suppression system. The container defines an inner volume, and battery cells positioned within the inner volume. The suppression system is configured to discharge suppressant agent into the inner volume of the container. The suppression system is configured to discharge the suppressant agent into the inner volume of the container at a variable rate in order to provide initial fire suppression, and continuous subsequent cooling of the plurality of battery cells.

In some embodiments, the suppression system is configured to discharge the suppressant agent at a first rate over a first time interval and a second rate over a second time interval. The second time interval may occur immediately after the first time interval and have a longer duration than the first time interval. The first rate may be greater than the second rate.

In some embodiments, the suppression system is configured to discharge the suppressant agent at a first rate over a first time interval and a second rate over a second time interval. The second time interval may occur a period of time after completion of the first time interval and have a longer duration than the first time interval. The first rate may be greater than the second rate. A value of the variable rate may be infinitely variable and the value of the variable rate may be adjusted directly in response to changes in temperature of the inner volume.

In some embodiments, the suppression system includes multiple pulse width modulated (PWM) nozzles that are configured to adjust an output flow rate of the suppressant agent according to the variable rate. The variable rate may include a pulsed rate of discharge of the suppressant agent. The suppression system may include a regulator configured to adjust an output flow rate of the suppressant agent according to the variable rate.

Another embodiment of the present disclosure is a vehicle. The vehicle includes a pack, and a suppression system. The pack defines an inner volume. Multiple battery cells are positioned within the inner volume. The suppression system is configured to discharge suppressant agent into the inner volume of the pack. The suppression system may be configured to discharge the suppressant agent into the inner volume of the pack at a variable rate in order to provide initial fire suppression and continuous subsequent cooling of the plurality of battery cells.

In some embodiments, the suppression system is configured to discharge the suppressant agent at a first rate over a first time interval and a second rate over a second time interval. The second time interval may occur immediately after the first time interval and have a longer duration than the first time interval. The first rate may be greater than the second rate.

In some embodiments, the suppression system is configured to discharge the suppressant agent at a first rate over a first time interval and a second rate over a second time interval. The second time interval may occur a period of time after completion of the first time interval and have a longer duration than the first time interval. The first rate may be greater than the second rate.

In some embodiments, a value of the variable rate is infinitely variable and the value of the variable rate is adjusted directly in response to changes in temperature of the inner volume. The suppression system may include multiple pulse width modulated (PWM) nozzles to achieve the variable rate.

In some embodiments, variable rate includes a pulsed rate of discharge of the suppressant agent. The suppression system may include a regulator that is configured to adjust an output flow rate of the suppressant agent according to the variable rate.

Another embodiment of the present disclosure is a method for suppressing a fire or thermal event at multiple battery cells that are positioned within an inner volume. The method includes discharging a first amount of suppressant agent to the inner volume over a first time period at a first flow rate. The method also includes discharging a second amount of suppressant agent to the inner volume over a second time period at a second flow rate. The second flow rate may be different than the first flow rate.

In some embodiments, the second time period occurs immediately after the first time period. In some embodiments, the second time period begins an amount of time after an end of the first time period.

In some embodiments, the first flow rate is greater than the second flow rate and the first time period is shorter than the second time period. In some embodiments, the steps of discharging the first amount of suppressant agent and discharging the second amount of suppressant agent are performed by operating a pulse width modulated (PWM) nozzle to discharge the first amount of suppressant agent at the first flow rate and the second amount of suppressant agent at the second flow rate. In some embodiments, the steps of discharging the first amount of suppressant agent and discharging the second amount of suppressant agent are performed by operating a regulator that is configured to adjust an output flow rate of the suppressant agent.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is a graph showing discharge flow rate of the suppressant of the suppression system of FIG. 1 including a first rate and a second rate over subsequent time intervals, according to an exemplary embodiment.

FIG. 6 is a graph showing discharge flow rate of the suppressant of the suppression system of FIG. 1 including a first rate and a second rate over time intervals that have an intermediate time period between them, according to an exemplary embodiment.

FIG. 7 is a schematic diagram of the suppression system of FIG. 1, including a controller, according to an exemplary embodiment.

FIG. 8 is a schematic diagram of the suppression system of FIG. 1, including a controller, according to another exemplary embodiment.

FIG. 9 is a schematic diagram of the suppression system of FIG. 1, including a controller, according to another exemplary embodiment.

FIG. 10 is a schematic diagram of the suppression system of FIG. 1, including a controller, according to another exemplary embodiment.

FIG. 11 is a schematic diagram of the suppression system of FIG. 1, including a controller, according to another exemplary embodiment.

FIG. 12 is a block diagram of a control system of the suppression system of FIGS. 1 and 7-11, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods can provide initial rapid agent application to quickly knockdown fire and begin cooling. Additional agent can be applied more slowly to enhance cooling and prevent propagation and reduce potential for future thermal runaway. The systems and methods can also include providing pulsed or continuous flow of agent to reduce heat generated by hazard over time, may remove fuel and hazard byproducts reducing potential for reignition, and may remove increases in conductivity that can lead to electrical shorting.

Stagnant agent around a hazard is unable to provide sustained cooling rate and may become contaminated with undesired increased electrolytes and electrical conductivity. Build-up of byproducts can reignite and/or create a hazardous environment for first responders. Advantageously, the systems and methods described herein can suppress or contain build-up of byproducts, and reduce a likelihood of reignition. In some embodiments, a flow rate of the agent or suppressant is continuously variable based on various detection signals obtained at the batteries. In some embodiments, the continuously variable flow rate of the agent or suppressant is controlled by operating pulse with modulated (PWM) nozzles. In some embodiments, the flow rate of the agent or suppressant is a two-stage fixed flow rate (e.g., a high flow rate over an initial time period, and then a lower flow rate over a second time period).

### System Overview

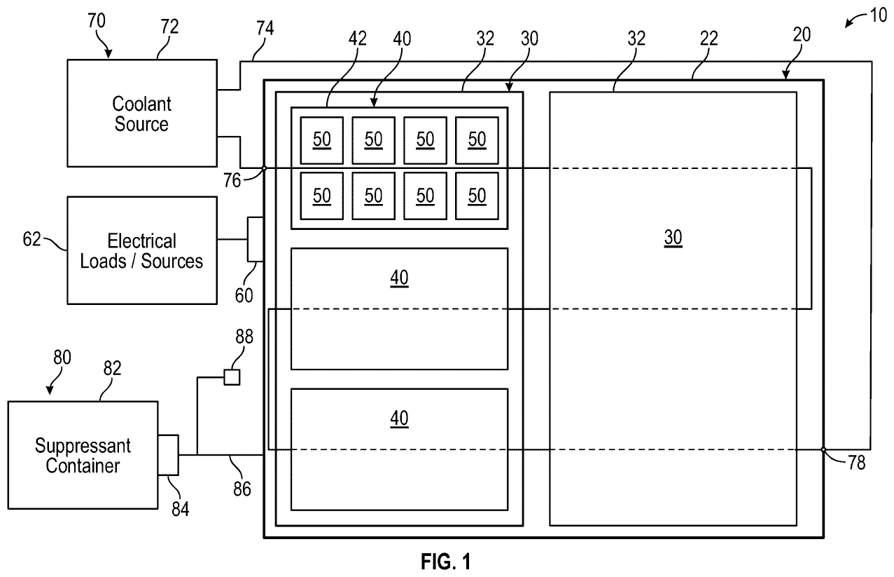

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88, that is positioned to direct suppressant to the exterior of the pack housing 22.

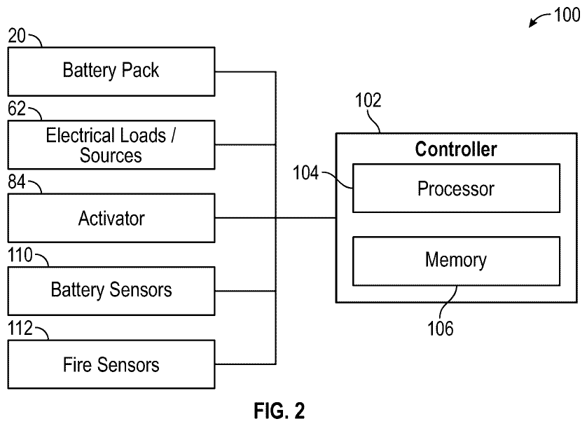

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the fire suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the fire suppression system 80.

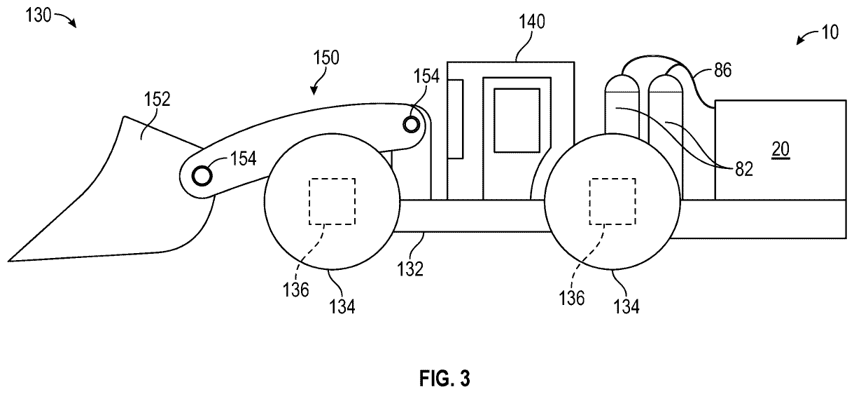

Referring to FIG. 3, a vehicle 130 is equipped with the battery system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

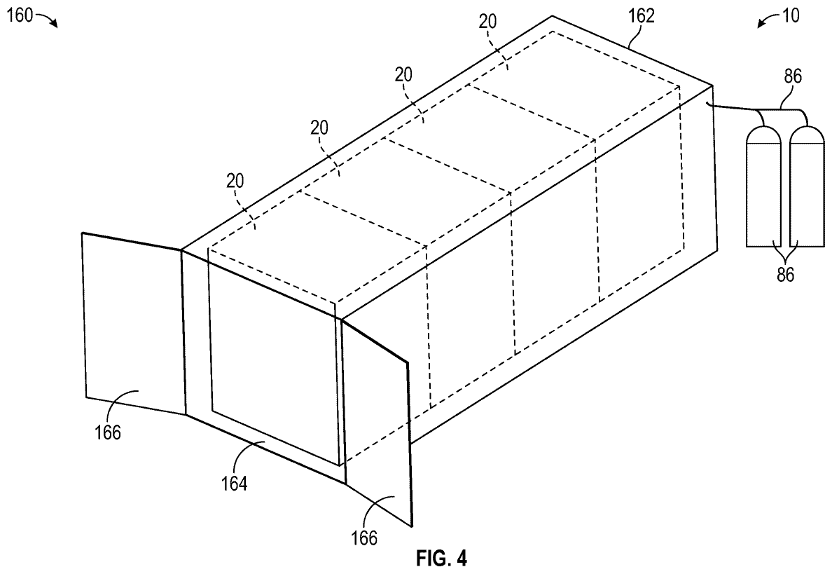

Referring to FIG. 4, a containerized energy storage system, shown as container system 160, is equipped with the battery system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

### Variable Flow Rate Suppression

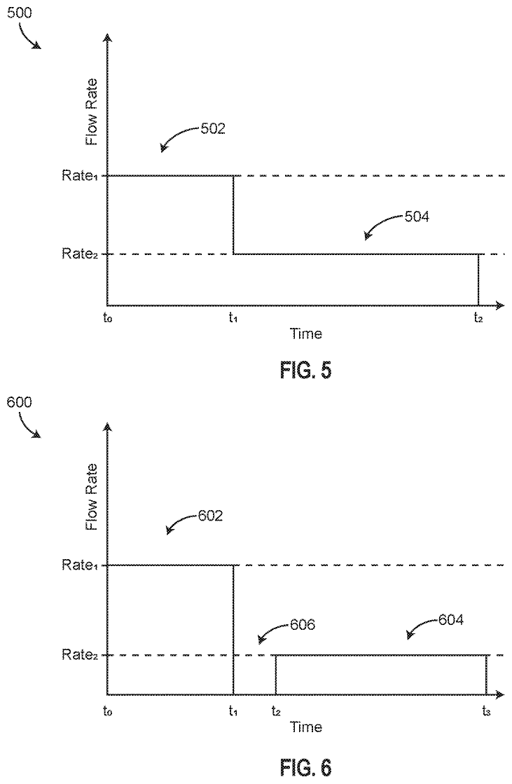

Referring to FIGS. 5 and 6, the suppression system 80 may be configured to provide the suppressant (e.g., an inert gas, a fire suppressant agent, etc.) at a variable rate to provide (i) an initial suppression stage to knock down or rapidly suppress any fire at the battery cells 50, and (ii) a subsequent suppression stage to continue cooling the battery cells 50 to reduce a likelihood of reignition or recombustion at the batteries 50 and maintain the batteries 50 in a cooled or suppressed state. In some embodiments, any of the systems and methods described herein with reference to FIGS. 5-12 are configured to operate similarly to any of the systems as described in U.S. application Ser. No. 17/602,141, filed Apr. 10, 2020, the entire disclosure of which is incorporated by reference herein. Advantageously, providing variable or changing flow rate of suppression to the battery cells 50 can effectively suppress thermal runaway of the battery cell 50 or the module by rapidly flooding the module. This may begin cooling and dilutes flammable vapors and liquids that are being released by the battery cells 50, and quench flames in the confined space within the module. Additionally, the suppression can be provided by multiple sets of nozzles 88 that provide suppressant at different flow rates. In some embodiments, during the initial discharge of suppressant, but before the inner volume is completely filled, the spray quenches any open flames and cools gases being emitted by the battery cells 50. Once flooding (e.g., the first stage or first time period of suppression) is complete, the low flow of suppression may continue to discharge to provide extended cooling over a longer second interval or stage.

Referring particularly to FIG. 5, a graph 500 illustrates a variable suppressant rate over two fixed rate intervals. The graph 500 illustrates flow rate (e.g., volumetric flow rate V of the suppressant, mass flow rate of the suppressant m) with respect to time. The graph 500 illustrates a first stage 502 and a second stage 504. The suppressant is discharged into the pack(s) 20 by the suppression system 80 over the first stage 502 (e.g., a first duration of time, until a first quantity of suppressant is discharged, etc.) at a first rate, Rate₁, and is discharged into the pack(s) 20 by the suppression system 80 over the second stage 504 (e.g., a second duration of time, until a first quantity of suppressant is discharged, etc.) at a second rate, Rate₂. In some embodiments, the flow rates Rate₁ and Rate₂ are different, with the first rate Rate₁ being greater than the second rate Rate₂. In some embodiments, the first stage 502 is across a time interval that is shorter than the time interval of the second stage 504. In this way, the first stage 502 can be performed in order to provide initial fire suppression, and the second stage can be performed to prevent reignition at the battery cells 50. The second stage 504 can be performed automatically in response to completing the first stage 502.

Referring to FIG. 6, a graph 600 illustrates another variable suppressant rate over two fixed rate intervals. The graph 600 illustrates flow rate similarly to the graph 500. The graph 600 includes a first stage 602 and a second stage 604. The first stage 602 and the second stage 604 can be the same as or similar to the first stage 502 and the second stage 504 of graph 500, respectively. In some embodiments, the variable suppressant rate shown in FIG. 6 also includes a transitory period 606 between the first stage 602 and the second stage 604 during which suppressant is not discharged into the packs 20. In some embodiments, the second stage 604 is initiated after the transitory period 606 automatically (e.g., after a certain amount of time has elapsed since completion of the first stage 602) or in response to a particular condition being present at the battery cells 50 (e.g., in response to temperature at the battery cells 50, the modules 40, the subpacks 30, the packs 20, etc., exceeding beyond a threshold, increasing at a rate greater than a threshold, in response to detection of an off-gas, etc.). In some embodiments, the suppression system 80 is operated by the controller 102 to discharge the suppressant according to either of the variable suppressant schemes as shown in FIGS. 5 and 6. In some embodiments, the time length or change of the first stage 502 and the second stage 504 (or the first stage 602 and the second stage 604) is determined (e.g., by the controller 102) based on a monitored temperature at the battery cells 50, the modules 40, the sub-packs 30, or the packs 20. In some embodiments, the monitored temperature is provided to the controller 102 by a thermocouple or an infrared sensor. In some embodiments, the time length or change of the first stage 502 and the second stage 504 (or the first stage 602 and the second stage 604) is determined based on the monitored temperature or a preset time period that is based on empirical testing for the given application. In some embodiments, the suppression system 80 is configured to return from the second stage at the lower flow rate to the first stage at the higher flow rate responsive to conditions (e.g., temperature) indicating that a higher flow rate of suppressant is required.

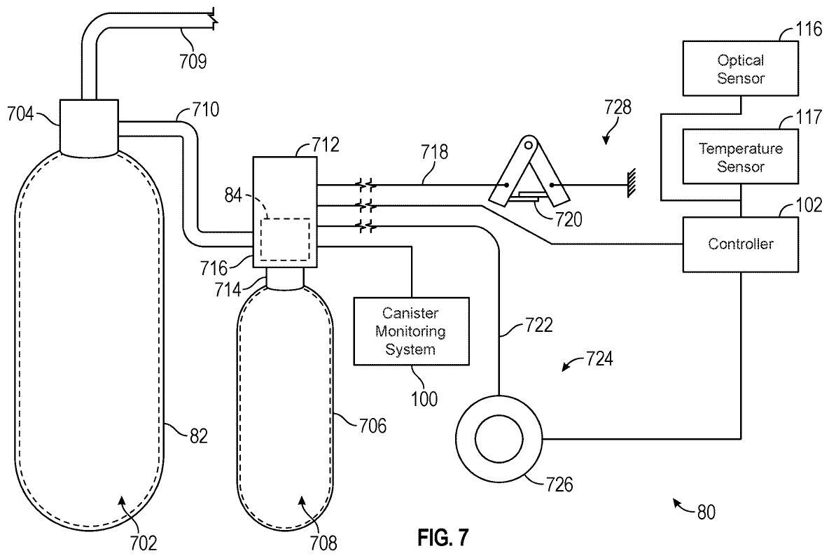

Referring now to FIG. 7, the suppression system 80 is shown according to an exemplary embodiment. In one embodiment, suppression system 80 is a chemical fire suppression system. Suppression system 80 is configured to dispense or distribute a fire suppressant agent onto and/or nearby a fire, extinguishing the fire and preventing the fire from spreading. Suppression system 80 can be used alone or in combination with other types of fire suppression systems (e.g., a building sprinkler system, a handheld fire extinguisher, etc.).

Referring still to FIG. 7, suppression system 80 includes a suppressant container 82 (e.g., a vessel, container, vat, drum, tank, canister, cartridge, or can, etc.). Suppressant container 82 defines an internal volume 702 filled (e.g., partially, completely, etc.) with fire suppressant agent. In some embodiments, the fire suppressant agent is normally not pressurized (e.g., is near atmospheric pressure). Suppressant container 82 includes an exchange section, shown as neck 704. Neck 704 permits the flow of expellant gas into internal volume 702 and the flow of fire suppressant agent out of internal volume 702 so that the fire suppressant agent can be supplied to a fire.

Suppression system 80 further includes a cartridge 706 (e.g., a vessel, container, vat, drum, tank, canister, cartridge, or can, etc.). Cartridge 706 defines an internal volume 708 configured to contain a volume of pressurized expellant gas. The expellant gas can be an inert gas. In some embodiments, the expellant gas is air, carbon dioxide, or nitrogen. Cartridge 706 includes an outlet portion or outlet section, shown as neck 714. Neck 714 defines an outlet fluidly coupled to internal volume 708. Accordingly, the expellant gas can leave cartridge 706 through neck 714. Cartridge 706 can be rechargeable or disposable after use. In some embodiments where cartridge 706 is rechargeable, additional expellant gas can be supplied to internal volume 708 through neck 714.

Suppression system 80 further includes a valve, puncture device, or activator assembly, shown as actuator 712 (e.g., activator 84). Actuator 712 includes an adapter, shown as receiver 716, that is configured to receive neck 714 of cartridge 706. Neck 714 is selectively coupled to receiver 716 (e.g., through a threaded connection, etc.). Decoupling cartridge 706 from actuator 712 facilitates removal and replacement of cartridge 706 when cartridge 706 is depleted. Actuator 712 is fluidly coupled to neck 704 of suppressant container 82 through a conduit or pipe, shown as hose 710.

Actuator 712 includes an activator 84 configured to selectively fluidly couple internal volume 708 to neck 704. In some embodiments, activator 84 includes one or more valves that selectively fluidly couple internal volume 708 to hose 710. The valves can be mechanically, electrically, manually, or otherwise actuated. In some such embodiments, neck 714 includes a valve that selectively prevents the expellant gas from flowing through neck 714. Such a valve can be manually operated (e.g., by a lever or knob on the outside of cartridge 706, etc.) or can open automatically upon engagement of neck 714 with actuator 712. Such a valve facilitates removal of cartridge 706 prior to depletion of the expellant gas. In other embodiments, cartridge 706 is sealed, and the activator 84 includes a pin, knife, nail, or other sharp object that actuator 712 forces into contact with cartridge 706. This punctures the outer surface of cartridge 706, fluidly coupling internal volume 708 with actuator 712. In some embodiments, activator 84 punctures cartridge 706 only when actuator 712 is activated. In some such embodiments, activator 84 omits any valves that control the flow of expellant gas to hose 710. In other embodiments, activator 84 automatically punctures cartridge 706 as neck 714 engages actuator 712.

Once actuator 712 is activated and cartridge 706 is fluidly coupled to hose 710, the expellant gas from cartridge 706 flows freely through neck 714, actuator 712, and hose 710 and into neck 704. The expellant gas enters suppressant container 82 and forces fire suppressant agent from suppressant container 82 out through neck 704 and into a conduit or hose, shown as pipe 709. In one embodiment, neck 704 directs the expellant gas from hose 710 to a top portion of internal volume 702. Neck 704 defines an outlet (e.g., using a syphon tube, etc.) near the bottom of suppressant container 82. The pressure of the expellant gas at the top of internal volume 702 forces the fire suppressant agent to exit through the outlet and into pipe 709. In other embodiments, the expellant gas enters a bladder within suppressant container 82, and the bladder presses against the fire suppressant agent to force the fire suppressant agent out through neck 704. In yet other embodiments, pipe 709 and hose 710 are coupled to suppressant container 82 at different locations. By way of example, hose 710 can be coupled to the top of suppressant container 82, and pipe 709 can be coupled to the bottom of suppressant container 82. In some embodiments, suppressant container 82 includes a burst disk that prevents the fire suppressant agent from flowing out through the neck 704 until the pressure within internal volume 702 exceeds a threshold pressure. Once the pressure exceeds the threshold pressure, the burst disk ruptures, permitting the flow of fire suppressant agent. Alternatively, suppressant container 82 can include a valve, a puncture device, or another type of opening device or activator assembly that is configured to fluidly couple internal volume 702 to pipe 709 in response to the pressure within internal volume 702 exceeding the threshold pressure. Such an opening device can be configured to activate mechanically (e.g., the force of the pressure causes the opening device to activate, etc.) or the opening device may include a separate pressure sensor in communication with internal volume 702 that causes the opening device to activate.

In some embodiments, pipe 709 is fluidly coupled to one or more outlets or sprayers, such as nozzles 88. The fire suppressant agent flows through pipe 709 and to the nozzles 88. The nozzles 88 can each define one or more apertures, through which the fire suppressant agent exits, forming a spray of fire suppressant agent that covers a desired area. The sprays from the nozzles 88 then suppress or extinguish fire within that area. The apertures of the nozzles 88 can be shaped to control the spray pattern of the fire suppressant agent leaving the nozzles 88. The nozzles 88 can be aimed such that the sprays cover specific points of interest (e.g., a specific piece of restaurant equipment, a specific component within an engine compartment of a vehicle, etc.). The nozzles 88 can be configured such that all of the nozzles 88 activate simultaneously, or the nozzles 88 can be configured such that only the nozzles near the fire are activated. In some embodiments, the nozzles 88 are positioned within the modules 40 and are configured to provide suppressant to the battery cells 50. In some embodiments, the nozzles 88 are positioned within the subpacks 30 and are configured to provide suppressant to the modules 40. In some embodiments, the nozzles 88 are positioned within the packs 20 and are configured to provide suppressant to the subpacks 30. In some embodiments, the nozzles 88 are positioned within the shipping container 162 and are configured to provide suppressant to the pack 20.

In some embodiments, the nozzles 88 are PWM nozzles that are operated by the controller 102 based on temperature at the battery cells 50, the modules 40, the subpacks 30, the packs 20, etc., or any combination thereof. In some embodiments, the nozzles 88 are the same as or similar to the PWM nozzles and are operated similarly to the PWM nozzles as described in greater detail with reference to U.S. application Ser. No. 17/615,651, filed Jun. 2, 2020, the entire disclosure of which is incorporated by reference herein.

Suppression system 80 further includes an automatic activation system 728 that controls the activation of actuator 712. Automatic activation system 728 is configured to monitor one or more conditions and determine if those conditions are indicative of a nearby fire. Upon detecting a nearby fire, automatic activation system 728 activates actuator 712, causing the fire suppressant agent to leave nozzles 88 and extinguish the fire.

In some embodiments, actuator 712 is controlled mechanically. As shown in FIG. 7, automatic activation system 728 includes a mechanical system including a tensile member (e.g., a rope, a cable, etc.), shown as cable 718, that imparts a tensile force on actuator 712. Without this tensile force, actuator 712 will activate. Cable 718 is coupled to a fusible link 720, which is in turn coupled to a stationary object (e.g., a wall, the ground, etc.). Fusible link 720 includes two plates that are held together with a solder alloy having a predetermined melting point. A first plate is coupled to cable 718, and a second plate is coupled to the stationary object. When the ambient temperature surrounding fusible link 720 exceeds the melting point of the solder alloy, the solder melts, allowing the two plates to separate. This releases the tension on cable 718, and actuator 712 activates. In other embodiments, automatic activation system 728 is another type of mechanical system that imparts a force on actuator 712 to activate actuator 712. Automatic activation system 728 can include linkages, motors, hydraulic or pneumatic components (e.g., pumps, compressors, valves, cylinders, hoses, etc.), or other types of mechanical components configured to activate actuator 712. Some parts of automatic activation system 728 (e.g., a compressor, hoses, valves, and other pneumatic components, etc.) can be shared with other parts of suppression system 80 (e.g., the manual activation system 60) or vice versa.

Actuator 712 can additionally or alternatively be configured to activate in response to receiving an electrical signal from automatic activation system 728. Referring to FIG. 7, automatic activation system 728 includes the controller 102 that monitors signals from one or more sensors, shown as temperature sensor 117 and optical sensor 116 (e.g., thermocouples, resistance temperature detectors, etc.). Controller 102 can use the signals from temperature sensor 117 (e.g., battery sensor 110, fire sensors 112, etc.) to determine if an ambient temperature has exceeded a threshold temperature. Upon determining that the ambient temperature has exceeded the threshold temperature, controller 102 provides an electrical signal to actuator 712. Actuator 712 then activates in response to receiving the electrical signal.

Suppression system 80 further includes a manual activation system 724 that controls the activation of actuator 712. Manual activation system 724 is configured to activate actuator 712 in response to an input from an operator. Manual activation system 724 can be included instead of or in addition to the automatic activation system 728. Both automatic activation system 728 and manual activation system 724 can activate actuator 712 independently. By way of example, automatic activation system 728 can activate actuator 712 regardless of any input from manual activation system 60, and vice versa.

As shown in FIG. 7, manual activation system 724 includes a mechanical system including a tensile member (e.g., a rope, a cable, etc.), shown as cable 722, coupled to actuator 712. Cable 722 is coupled to a human interface device (e.g., a button, a lever, a switch, a knob, a pull ring, etc.), shown as button 726. Button 726 is configured to impart a tensile force on cable 722 when pressed, and this tensile force is transferred to actuator 712. Actuator 712 activates upon experiencing the tensile force. In other embodiments, manual activation system 724 is another type of mechanical system that imparts a force on actuator 712 to activate actuator 712. Manual activation system 724 can include linkages, motors, hydraulic or pneumatic components (e.g., pumps, compressors, valves, cylinders, hoses, etc.), or other types of mechanical components configured to activate the actuator 712.

Actuator 712 can additionally or alternatively be configured to activate in response to receiving an electrical signal from manual activation system 60. As shown in FIG. 7, button 726 is operably coupled to controller 102. Controller 102 can be configured to monitor the status of a human interface device (e.g., engaged, disengaged, etc.). Upon determining that the human interface device is engaged, the controller provides an electrical signal to activate actuator 712. By way of example, controller 102 can be configured to monitor a signal from button 726 to determine if button 726 is pressed. Upon detecting that button 726 has been pressed, controller 102 sends an electrical signal to actuator 712 to activate actuator 712.

Automatic activation system 728 and manual activation system 724 are shown to activate actuator 712 both mechanically (e.g., though application of a tensile force through cables, through application of a pressurized liquid, through application of a pressurized gas, etc.) and electrically (e.g., by providing an electrical signal). It should be understood, however, that automatic activation system 728 and/or manual activation system 724 can be configured to activate actuator 712 solely mechanically, solely electrically, or through some combination of both. By way of example, automatic activation system 728 can omit controller 102 and activate actuator 712 based on the input from fusible link 720. By way of another example, automatic activation system 728 can omit fusible link 720 and activate actuator 712 using an input from controller 102.

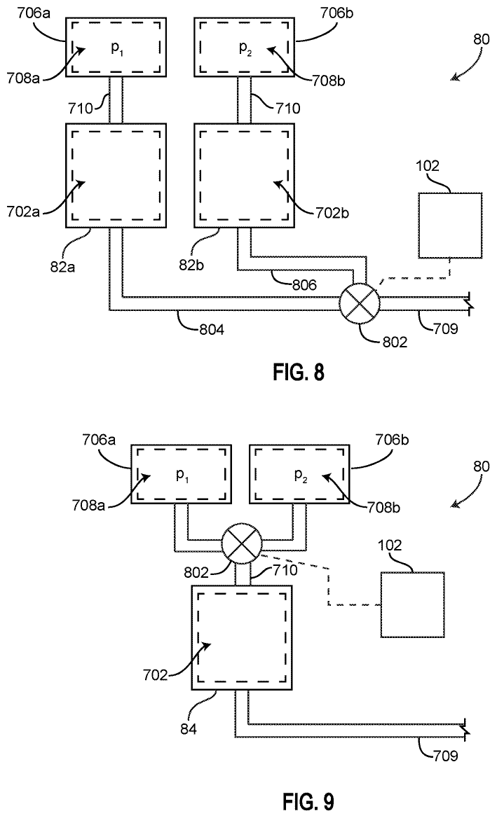

Referring now to FIG. 8, suppression system 80 is shown according to another embodiment. Suppression system 80 as shown in FIG. 8 may include any or all of the components, features, activation mechanisms, etc., as described in greater detail above with reference to FIG. 7. Suppression system 80 is configured to provide fire suppressant agent contained within internal volume 702a and internal volume 702b of suppressant container 82a and suppressant container 82b, respectively, to distribution network 86 via pipe 709. Suppressant container 82a and suppressant container 82b are fluidly coupled to cartridge 706a and cartridge 706b, respectively. Cartridge 706a includes propellant gas within internal volume 708a. Likewise, cartridge 706b contains propellant gas within internal volume 708b. The propellant gas of cartridge 706a is pressurized at pressure p₁, while the propellant gas of cartridge 706b is pressurized at pressure p₂. Suppressant container 82a is fluidly coupled to valve 802 via a tube, pipe, connector, hose, etc., shown as pipe 804. Suppressant container 82b is similarly fluidly coupled to valve 802 via pipe 806. Valve 802 is configured to transition between various configurations to fluidly couple suppressant container 82a to pipe 709 when in a first configuration and to fluidly couple suppressant container 82b to pipe 709 when in a second configuration.

In an exemplary embodiment, controller 102 is configured to operably connect with valve 802 to transition valve 802 between the first configuration and the second configuration. For example, valve 802 may be configured to transition between the first configuration and the second configuration via an actuator which can be controlled by controller 102. Controller 102 is configured to transition valve 802 from the first configuration to the second configuration at time t₁.

Cartridge 706a is at pressure p₁ and cartridge 706b is at pressure p₂, with p₁>p₂. This results in the fire suppressant agent driven out of the corresponding suppressant containers 82 being provided to pipe 709 at different volumetric flow rates. In some embodiments, p₁ is such that fire suppressant agent which exits suppressant container 82a exits at a flow rate of \dot{V}₁. Likewise, p₂ may be such that fire suppressant agent which exits suppressant container 82b exits at a flow rate of \dot{V}₂. Additionally, internal volume 702a of suppressant container 82a may be substantially equal to the volume V_{A} of fire suppressant agent provided over first period 304 (see FIG. 3), and internal volume 702b of suppressant container 82b may be substantially equal to the volume V_{B} of fire suppressant agent provided over second period 306.

Controller 102 may actuate valve 802 into the first configuration such that pipe 709 is fluidly coupled with suppressant container 82a. The fire suppressant agent contained within internal volume 702a of suppressant container 82a is pressurized by the propellant gas within internal volume 708a of cartridge 706a (the propellant gas at pressure p₁) and exits suppressant container 82a at a flow rate of \dot{V}₁. Controller 102 maintains valve 802 in the first configuration such that the fire suppressant agent from suppressant container 82a is provided to nozzles 88 at \dot{V}₁ until t=t₁. At time t=t₁, controller 102 transitions valve 802 into the second configuration such that suppressant container 82b is fluidly coupled with pipe 709 and is configured to provide the fire suppressant agent therewithin to nozzles 88 via pipe 709. Since the propellant gas of cartridge 706b is at pressure p₂ which is less than pressure p₁, the fire suppressant agent exits suppressant container 82b at a flow rate \dot{V}₂. In this way, controller 102 can control valve 802 such that the fire suppressant agent is provided to piping system 110 at a first flow rate \dot{V}₁ over first period 304, and a second flow rate \dot{V}₂, where \dot{V}₂<\dot{V}₁.

It should be noted that cartridge 706a and suppressant container 82a may be configured similarly as described in greater detail above with reference to FIG. 7 such that cartridge 706a pressurizes suppressant container 82a. Likewise, cartridge 706a and suppressant container 82a may be similarly configured. Furthermore, other suitable configurations of suppressant tanks, cartridges, and corresponding pressures of expellant/propellant gas can be used to provide a desired first and second flow rate of the fire suppressant agent. For example, the volume, size, shape, etc., of suppressant container 82a and suppressant container 82b may be adjusted alone or in combination with adjustments to p₁ and p₂ such that cartridge 706a and suppressant container 82a provide fire suppressant agent at \dot{V}₁ and cartridge 706b and suppressant container 82b provide fire suppressant agent at \dot{V}₂, where \dot{V}₂<\dot{V}₁.

Referring now to FIG. 9, suppression system 80 is shown in greater detail according to another embodiment. Suppression system 80 as shown in FIG. 9 may share any of the features, configuration, components, etc., of suppression system 80 as described in greater detail above with reference to FIG. 7. Additionally, suppression system 80 as shown in FIG. 9 may include any of the features, configuration, components, etc., of suppression system 80 as described in greater detail above with reference to FIG. 8.

Suppression system 80 can include valve 802 fluidly coupled to cartridge 706a and cartridge 706b. Valve 802 is fluidly coupled to suppressant container 82 such that the flow of expellant gas through valve 802 drives the fire suppressant agent contained within suppressant container 82 through pipe 709 to piping system 110. Valve 802 is fluidly coupled upstream of suppressant container 82 and is configured to provide expellant gas within cartridge 706a to suppressant container 82 when in a first configuration and to provide expellant gas within cartridge 706a to suppressant container 82 when in a second configuration. The expellant gas within cartridge 706a is at a pressure p₁ while the expellant gas within cartridge 706b is at a pressure p₂ where p₁>p₂. The pressure p₁ of the expellant gas within cartridge 706a is such that the fire suppressant agent is provided to piping system 110 at flow rate \dot{V}₁ when valve 802 is in the first configuration. Likewise, the pressure p₂ of the expellant gas within cartridge 706b is such that the fire suppressant agent is provided to piping system 110 at a flow rate \dot{V}₂ (e.g., 50% of \dot{V}₁) when valve 802 is in the second configuration, where \dot{V}₂<\dot{V}₁. In this way, transitioning valve 802 between the first and the second configuration controls the volumetric flow rate of fire suppressant agent provided to piping system 110. Controller 102 is shown communicably connected with valve 802. Controller 102 is configured to transition valve 802 between the first configuration and the second configuration to control the volumetric flow rate of fire suppressant agent provided to piping system 110. Controller 102 can be configured to transition valve 802 from the first configuration into the second configuration at a desired time (e.g., at t₁) to achieve variable/dual flow rate of the fire suppressant agent provided to piping system 110.

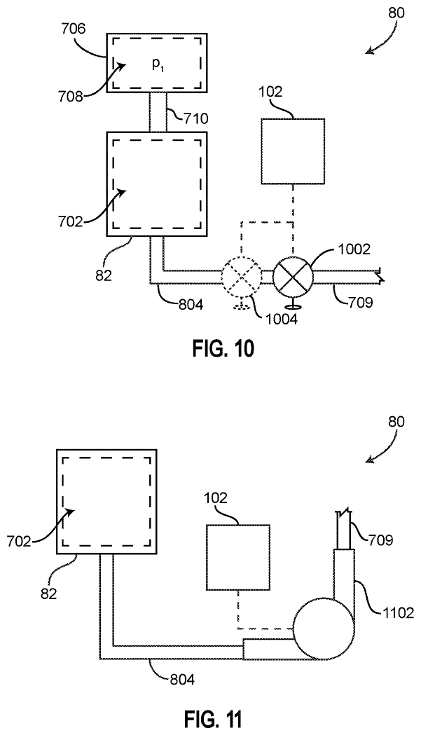

Referring now to FIG. 10, suppression system 80 is shown, according to another embodiment. Suppression system 80 includes cartridge 706 configured to contain expellant gas at a high pressure therewithin and fluidly couple with suppressant container 82. When suppression system 80 is activated, the expellant gas pressurizes and drives the fire suppressant agent contained within suppressant container 82 to piping system 110 via pipe 709. Cartridge 706 includes internal volume 708 configured to contain the expellant gas therewithin. Suppressant container 82 includes internal volume 702 configured to contain the fire suppressant agent therewithin. Internal volume 702 of suppressant container 82 can be fluidly coupled with pipe 709 via pipe 804.

Suppression system 80 is shown to include a regulator 1002 (e.g., a PWM controlled regulator) disposed between pipe 804 and pipe 709. Regulator 1002 is disposed downstream of suppressant container 82 and is configured to control/adjust the flow rate of fire suppressant agent provided to pipe 709, according to some embodiments. In other embodiments, regulator 1002 (and/or regulator 1004) is disposed downstream of cartridge 706 and upstream of suppressant container 82 and is configured to control/adjust the flow rate of expellant gas used to mobilize the fire suppressant agent within suppressant container 82, thereby controlling/adjusting the flow rate of fire suppressant agent provided to pipe 709.

Regulator 1002 may be a single state or a multi-stage regulator. In other embodiments, regulator 1002 is an adjustable orifice regulator/valve/nozzle. If regulator 1002 is a single stage regulator, regulator 1004 (another single stage regulator) is included fluidly coupled with regulator 1002 either upstream or downstream of regulator 1002. Regulator 1002 and/or regulator 1004 can be any of pressure compensated flow regulators, temperature compensated flow regulators, etc. Regulator 1002 and/or regulator 1004 are configured to control/adjust the flow rate of fire suppressant agent provided to pipe 709 and piping system 110. Regulator 1002 and/or regulator 1004 may receive control signals from controller 102. The control signals may indicate when to adjust regulator 1002 and/or regulator 1004 to affect the flow rate of the fire suppressant agent provided to pipe 709 and piping system 110. For example, regulator 1002 and/or regulator 1004 can receive a control signal from controller 102 at a first time to to produce volumetric flow rate \dot{V}₁. Regulator 1002 and/or regulator 1004 can use the control signal to adjust such that the fire suppressant agent is provided to pipe 709 and piping system 110 at volumetric flow rate \dot{V}₁. Regulator 1002 and/or regulator 1004 may receive another control signal from controller 102 at a later time (e.g., at time t₁) indicating that the volumetric flow rate should be reduced to \dot{V}₂. Regulator 1002 and/or regulator 1004 can use the control signal to adjust such that the fire suppressant agent is provided to pipe 709 and piping system 110 at the volumetric flow rate \dot{V}₂. Regulator 1002 and/or regulator 1004 may include actuators configured to receive the control signals from controller 102 and adjust an operation of regulator 1002 and/or regulator 1004 to achieve the desired flow rate (e.g., \dot{V}₁ or \dot{V}₂). In some embodiments, the regulator 1002 is a high pressure regulator, and the regulator 1004 is a low pressure regulator. In some embodiments, the controller 102 is configured to switch activation from the regulator 1002 (e.g., the high pressure regulator) to the regulator 1004 (e.g., the low pressure regulator) after a time period to change the flow rate. The time period may be a preset or pre-determined time period that is based on empirical testing for the given application.

Referring now to FIG. 11, suppression system 80 is shown, according to another embodiment. Suppression system 80 includes suppressant container 82 having internal volume 702 configured to contain fire suppressant agent therewithin. Suppressant container 82 is fluidly coupled with pipe 709 (and piping system 110) via pipe 804 and pump 1102 (e.g., a PWM pump). Pump 1102 may be positioned upstream of suppressant container 82 (as a discharge pump) to drive the fire suppressant agent through pipe 709 and piping system 110, or may be positioned downstream of suppressant container 82 (as a suction pump) to draw the fire suppressant agent through pipe 804 and drive the fire suppressant agent through pipe 709 to piping system 110. Pump 1102 may be a variable speed pump such that pump 1102 is configured to provide the fire suppressant agent to piping system 110 at a variable or adjustable flow rate. Controller 102 is configured to provide control signals to pump 1102 to adjust the flow rate of the fire suppressant agent provided to piping system 110. Controller 102 may provide a first set of control signals that cause pump 1102 to operate such that the fire suppressant agent is provided to piping system 110 at a first flow rate (e.g., \dot{V}₁) and later provide a second set of control signals that cause pump 1102 to operate such that the fire suppressant agent is provided to piping system 110 at a second flow rate (e.g., \dot{V}₂) where the second flow rate is less than the first flow rate (or greater than).

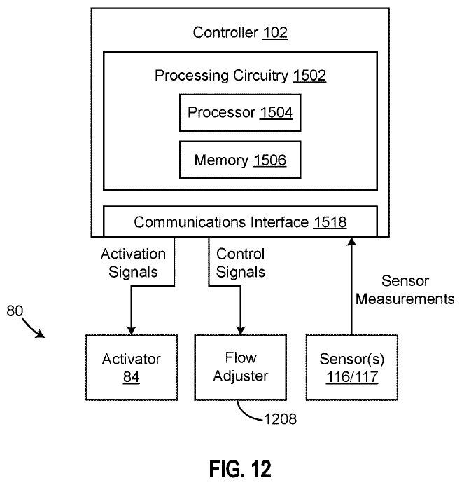

Referring now to FIG. 12, controller 102 is shown in greater detail, according to an exemplary embodiment. Controller 102 is shown to include a processing circuitry 1502 including a processor 1504 and memory 1506. Processor 1504 may be a general purpose or specific purpose processor, an application specific integrated circuit (ASIC), one or more field programmable gate arrays (FPGAs), a group of processing components, or other suitable processing components. Processor 1504 is configured to execute computer code or instructions stored in memory 1506 or received from other computer readable media (e.g., CDROM, network storage, a remote server, etc.).

Memory 1506 may include one or more devices (e.g., memory units, memory devices, storage devices, etc.) for storing data and/or computer code for completing and/or facilitating the various processes described in the present disclosure. Memory 1506 may include random access memory (RAM), read-only memory (ROM), hard drive storage, temporary storage, non-volatile memory, flash memory, optical memory, or any other suitable memory for storing software objects and/or computer instructions. Memory 1506 may include database components, object code components, script components, or any other type of information structure for supporting the various activities and information structures described in the present disclosure. Memory 1506 may be communicably connected to processor 1504 via processing circuitry 1502 and may include computer code for executing (e.g., by processor 1504) one or more processes described herein. When processor 1504 executes instructions stored in memory 1506, processor 1504 generally configures controller 102 (and more particularly processing circuitry 1502) to complete such activities.

In some embodiments, controller 102 includes a data communications interface 1518 (e.g., a USB port, a wireless transceiver, etc.) configured to receive and transmit data. Communications interface 1518 may include wired or wireless communications interfaces (e.g., jacks, antennas, transmitters, receivers, transceivers, wire terminals, etc.) for conducting data communications external systems or devices. In various embodiments, the communications may be direct (e.g., local wired or wireless communications) or via a communications network (e.g., a WAN, the Internet, a cellular network, etc.). For example, communications interface 1518 can include a USB port or an Ethernet card and port for sending and receiving data via an Ethernet-based communications link or network. In another example, communications interface 1518 can include a Wi-Fi transceiver for communicating via a wireless communications network or cellular or mobile phone communications transceivers.

Referring still to FIG. 12, controller 102 is shown communicably connected with sensors 116/117 (e.g., temperature sensor 117 and optical sensor 116, battery sensors 110, fire sensors 112, etc.) via communications interface 1518. The controller 102 is configured to receive one or more sensor readings/measurements from sensors 116/117. The controller 102 be configured to receive a signal associated with the sensor measurements and determine a value of the sensor measurements (e.g., in degrees Fahrenheit, intensity of light in kW, etc.) based on the received signals. In some embodiments, the controller 102 is configured to use the value of the sensor measurements to determine activation or control signals for the suppression system 80.

Referring still to FIG. 12, the controller 102 is configured to monitor the values of the sensor measurements/readings and determine if suppression system 80 should be activated. For example, the controller 102 may monitor the values of the temperature measurements/readings, and if the value of the temperature measurements/readings exceeds a predetermined threshold value or is increasing at a rate over a predetermined threshold value, the controller 102 determines that suppression system 80 should be activated. The controller 102 can provide activation signals to activator 84 to activate suppression system 80 in response to the sensor measurements. In some embodiments, the controller 102 is configured to record a start time, to at which suppression system 80 is activated. The controller 102 is configured to track an amount of elapsed time since the start time to and use the amount of elapsed time to determine when to change into different stages of suppression (e.g., when to vary the flow rate at which the suppressant is discharged by the suppression system 80).

The controller 102 can also provide control signals to a flow adjuster 1208. Flow adjuster 1208 may represent any of regulator(s) 1002/1004, valve 802, pump 1102, the nozzles 88 (e.g., PWM nozzles), etc., or any other controllable element described in greater detail hereinabove configured to adjust a flow rate of fire suppressant agent discharged by the suppression system 80. In other embodiments, flow adjuster 1208 is a spring-loaded nozzle and/or an actuator associated with a spring-loaded nozzle, configured to adjust the spring-loaded nozzle (e.g., configured to adjust an orifice) to affect the flow rate of fire suppressant agent. In response to receiving the indication that suppression system 80 should be activated, or in response to suppression system 80 activating, control signal generator 1516 can provide flow adjuster 1208 with a control signal to discharge the fire suppressant agent from the suppression system 80 at a variable flow rate, or at a first value of a variable flow rate such as \dot{V}₁ or Rate₁.

The controller 102 can monitor the elapsed time since time t₀. The controller 102 can send another control signal to flow adjuster 1208 to decrease the flow rate (e.g., reduce to \dot{V}₂ or Rate₂) in response to a predetermined amount of time passing since time t₀. For example, the controller 102 can send the control signal to flow adjuster 1208 to decrease the flow rate at time t₁ (e.g., 7 seconds).

In other embodiments, the controller 102 causes the flow adjuster 1208 to adjust the flow rate based on values of the sensor measurements. For example, the controller 102 may monitor the received temperature value (e.g., as sensed by temperature sensor 117 or the fire sensor 112 or the battery sensors 110) and compare the received temperature value to a threshold value. Once the received temperature value has decreased below the threshold value, the controller 102 may cause flow adjuster 1208 to decrease the flow rate of the suppressant (e.g., decrease from \dot{V}₁ to \dot{V}₂ or from Rate₁ to Rate₂). Likewise, the controller 102 may monitor the received light intensity measurement (as measured by optical sensor 116). Once the received light intensity measurement decreases below a predetermined threshold value, the controller 102 can cause flow adjuster 1208 to reduce the flow rate of the fire suppressant agent.

In some embodiments, the controller 102 is configured to operate the suppression system 80 (e.g., the flow adjuster 1208) to provide multiple states of fire suppression where the suppressant is provided at different fixed flow rate across different time intervals. In some embodiments, the controller 102 is configured to operate the flow adjuster 1208 to provide pulsed flow of the suppressant across one or more time intervals or stages. In some embodiments, any significant amount of heat inside the modules 40 is absorbed by the agent to mitigate a likelihood of heat transfer to other modules 40. In some embodiments, the controller 102 is configured to operate the activator 84 and the flow adjuster 1208 to provide activation and discharge every time the temperature at the battery cells 50, the modules 40, the subpacks 30, the packs 20, etc., exceeds beyond a threshold amount. In some embodiments, the controller 102 operates the suppression system 80 (e.g., by operating the flow adjuster 1208 and the activator 84) to provide suppressant until the temperature is driven below the threshold amount.

In some embodiments, the controller 102 is configured to use the temperature obtained from the sensors 116, 117, 110, 112, etc., to provide continuously adjustable or variable flow or discharge of the suppressant into the packs 20 (or into the modules 40, into the subpacks 30, into the packs 20, etc.). In some embodiments, the controller 102 is configured to decrease the rate at which the suppressant is discharged in response to decreases in temperature. In some embodiments, the controller 102 is configured to increase the rate at which the suppressant is discharged in response to increases in temperature. In this way, the rate at which suppressant is discharged can be directly proportional to the temperature at the battery cells 50, the modules 40, the subpacks 30, the packs 20, etc. In some embodiments, the suppression system 80 is configured to be operated by the controller 102 to provide liquid CO2 into the packs 20 at intervals.

Referring again to FIGS. 1, and 8-11, the suppression system 80 may include two sets of the nozzles 88 (e.g., high flow nozzles and low flow nozzles) that are each fluidly coupled with a separate valve (e.g., the regulators 1004 and 1002). In some embodiments, all of the nozzles 88 are activated initially over the first stage to provide high flow of the suppressant over the first time period and then the high flow nozzles 88 are deactivated (e.g., by operating the separate valves) to provide low flow of the suppressant agent over the second stage or time period. Similarly, the high flow nozzles 88 may be initially activated by opening the corresponding valve, and then switched to activation of the low flow nozzles 88 by opening the corresponding valve for the low flow nozzles 88 and closing the valve for the high flow nozzles 88.

### Configuration of the Exemplary Embodiments

As utilized herein with respect to numerical ranges, the terms “approximately,” “about,” “substantially,” and similar terms generally mean +/-10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A container system comprising:
a container defining an inner volume, a plurality of battery cells positioned within the inner volume; and
a suppression system configured to discharge suppressant agent into the inner volume of the container;
wherein the suppression system is configured to discharge the suppressant agent into the inner volume of the container at a variable rate in order to provide initial fire suppression, and continuous subsequent cooling of the plurality of battery cells.

2. The container system of claim 1, wherein the suppression system is configured to discharge the suppressant agent at a first rate over a first time interval and a second rate over a second time interval, the second time interval occurring immediately after the first time interval and having a longer duration than the first time interval, and the first rate being greater than the second rate.

3. The container system of claim 1, wherein the suppression system is configured to discharge the suppressant agent at a first rate over a first time interval and a second rate over a second time interval, the second time interval occurring a period of time after completion of the first time interval and having a longer duration than the first time interval, and the first rate being greater than the second rate.

4. The container system of claim 1, wherein a value of the variable rate is infinitely variable and the value of the variable rate is adjusted directly in response to changes in temperature of the inner volume.

5. The container system of claim 1, wherein the suppression system comprises a plurality of pulse width modulated (PWM) nozzles configured to adjust an output flow rate of the suppressant agent according to the variable rate.

6. The container system of claim 1, wherein the variable rate comprises a pulsed rate of discharge of the suppressant agent.

7. The container system of claim 1, wherein the suppression system comprises a regulator configured to adjust an output flow rate of the suppressant agent according to the variable rate.

8. A vehicle comprising:
a pack defining an inner volume, a plurality of battery cells positioned within the inner volume; and
a suppression system configured to discharge suppressant agent into the inner volume of the pack;
wherein the suppression system is configured to discharge the suppressant agent into the inner volume of the pack at a variable rate in order to provide initial fire suppression and continuous subsequent cooling of the plurality of battery cells.

8. ehicle of claim 8, wherein the suppression system is configured to discharge the suppressant agent at a first rate over a first time interval and a second rate over a second time interval, the second time interval occurring immediately after the first time interval and having a longer duration than the first time interval, and the first rate being greater than the second rate.

10. The vehicle of claim 8, wherein the suppression system is configured to discharge the suppressant agent at a first rate over a first time interval and a second rate over a second time interval, the second time interval occurring a period of time after completion of the first time interval and having a longer duration than the first time interval, and the first rate being greater than the second rate.

11. The vehicle of claim 8, wherein a value of the variable rate is infinitely variable and the value of the variable rate is adjusted directly in response to changes in temperature of the inner volume.

12. The vehicle of claim 8, wherein the suppression system comprises a plurality of pulse width modulated (PWM) nozzles to achieve the variable rate.

13. The vehicle of claim 8, wherein the variable rate comprises a pulsed rate of discharge of the suppressant agent.

14. The vehicle of claim 8, wherein the suppression system comprises a regulator configured to adjust an output flow rate of the suppressant agent according to the variable rate.

15. A method for suppressing a fire or thermal event at a plurality of battery cells positioned within an inner volume, the method comprising:
discharging a first amount of suppressant agent to the inner volume over a first time period at a first flow rate; and
discharging a second amount of suppressant agent to the inner volume over a second time period at a second flow rate, the second flow rate being different than the first flow rate.

16. The method of claim 15, wherein the second time period occurs immediately after the first time period.

17. The method of claim 15, wherein the second time period begins an amount of time after an end of the first time period.

18. The method of claim 15, wherein the first flow rate is greater than the second flow rate and the first time period is shorter than the second time period.

19. The method of claim 15, wherein the steps of discharging the first amount of suppressant agent and discharging the second amount of suppressant agent are performed by operating a pulse width modulated (PWM) nozzle to discharge the first amount of suppressant agent at the first flow rate and the second amount of suppressant agent at the second flow rate.

20. The method of claim 15, wherein the steps of discharging the first amount of suppressant agent and discharging the second amount of suppressant agent are performed by operating a regulator that is configured to adjust an output flow rate of the suppressant agent.
